(19) United States
(12) Patent Application Publication
(10) Pub. No.: US 2018/0036763 A1
(43) Pub. Date: Feb. 8, 2018

(54) MICROFLUIDIC DEVICE FOR THERMALLY SPRAYING A LIQUID CONTAINING PIGMENTS AND/OR AROMA PRONE TO AGGREGATION OR DEPOSITION

(71) Applicant: STMICROELECTRONICS S.R.L., Agrale Brianza (IT)

(72) Inventors: Domenico GIUSTI, Monza (IT); Lorenzo TENTORI, Verano Brianza (IT)

(21) Appl. No.: 15/470,549

(22) Filed: Mar. 27, 2017

(30) Foreign Application Priority Data
Aug. 5, 2016 (IT) 102016000083000

(51) Int. Cl. B05D 1/02; B05B 1/24

(52) U.S. Cl. CPC B05D 1/02; B05B 1/24

(57) ABSTRACT

A microfluidic device for thermally spraying a liquid, comprising a plurality of chambers, a plurality of nozzles arranged over the chambers, a plurality of channel heaters in proximity of each chamber, a liquid access connected to the chambers, and a circulation channel integrated in the body and connected to the liquid access. A heater along the circulation channel maintains the liquid in motion during inactivity of the device, preventing deposition or aggregation of particles in the liquid.

### BACKGROUND

### Technical Field

The present disclosure relates to a microfluidic device for thermally spraying a liquid containing pigments and/or aroma prone to aggregation or deposition.

### Description of the Related Art

As is known, for thermal spraying inks and/or aroma, for example in printers and perfumes, the use of microfluidic devices of small dimensions has been proposed, since they can be obtained with microelectronic manufacturing techniques.

For instance, U.S. Pat. No. 9,174,445 discloses a microfluidic device designed for thermally spraying ink on paper.

FIG. 1 shows a chamber 11 of a microfluidic device 10 for thermally spraying inks and aroma, similar to the one described in the above patent. The chamber 11 illustrated in FIG. 1 is formed in a chamber layer 12 and is delimited, at the bottom, by a thin layer 13, of dielectric material, and, at the top, by a nozzle plate 14.

A nozzle 15 is formed through the nozzle plate 14 and has a first portion 15A, facing the chamber 11, and a second portion 15B, facing the opposite direction (towards the outside of the microfluidic device 10). The first portion 15A is significantly wider than the second portion 15B. A heater 20 is formed in the thin layer 13 so as to be adjacent to the chamber 11 and arranged at the nozzle 15. The heater 20 may have an area of approximately 40×40 μm², generate, for example, an energy of 3.5 μJ, and is able to reach a maximum temperature of 450° C. in 2 μs.

The chamber 11 is moreover provided with a fluidic access 21 enabling inlet and transport of the liquid in the chamber 11, as indicated by the arrow L. A plurality of columns (not visible in FIG. 1) may be formed in the fluidic access 21, and have the aim of preventing bulky particles from clogging the fluidic access 21.

In the microfluidic device 10, the chambers 11 are connected through the fluidic accesses 21 to a supply system (not illustrated).

The operation of the chamber 11 is represented schematically in FIGS. 2A-2E. The liquid L reaches the chamber 11 through the fluidic access 21 (FIG. 2A), forming a liquid layer 16 of, for example, 0.3 μm in thickness. The heater 20 heats the liquid layer 16 up to a preset temperature (FIG. 2B). This temperature is chosen, according to the liquid used, so as to instantaneously reach boiling point, for example at a temperature close to 300° C. In this situation, the pressure rises to a high level, for example, approximately 5 atm, forming a vapor bubble 17, which disappears after a few microseconds, for example 10-15 μs, as illustrated in FIGS. 2C-2D. The pressure thus generated pushes a drop of liquid 18 through the nozzle 15, after which the liquid layer 16 returns to its initial condition (FIG. 2E).

The entire cycle is repeated up to ten thousand times per second, supplied by the liquid that continuously arrives through the fluidic access 21.

Many fluids used in thermal-spraying devices contain pigments that tend to aggregate easily, causing, in time, clogging of the supply system and thus failure in the functioning of the thermal-spraying device.

To overcome this problem, external liquid-movement means have been proposed. For instance, an external system of pumps and pressure regulators has been proposed, as illustrated in FIG. 3. By virtue of the illustrated system, designated as a whole at 25, the liquid is constantly filtered in a filtering and pressure-control stage 26 in order to prevent clogging of the nozzles 15. A heater 27 has the aim of keeping the liquid at a constant temperature, for example 40° C., and is kept in continuous circulation by each of the chambers 11 through a pump 28.

Furthermore, the system 25 illustrated in FIG. 3 generates a “meniscus vacuum”, i.e., a slight negative pressure inside the chambers 11 that keeps the nozzles 15 in optimal conditions and ready to emit the liquid. The system can also continuously remove the bubbles from the liquid by a degasser 29.

However, this solution to the problem of pigment aggregation has the disadvantage of requiring a bulky recirculation system outside the thermal spraying device. It is moreover costly.

### BRIEF SUMMARY

According to one or more embodiments of the present disclosure, a microfluidic device for thermally spraying a liquid is provided, as well as a method for operating a microfluidic device. In one or more embodiments, the microfluidic device provides a simple and effective recirculation system that prevents deposition and aggregation of pigments of particles in the liquid.

### BRIEF DESCRIPTION OF THE SEVERAL VIEWS OF THE DRAWINGS

For a better understanding of the present disclosure, a preferred embodiment thereof is now described, purely by way of non-limiting example, with reference to the attached drawings, wherein:

FIG. 1 is a cross-sectional perspective view of a chamber of a known thermal spraying device;

FIGS. 2A-2E illustrate operations of the chamber of FIG. 1;

FIG. 3 is a schematic block scheme of an external recirculation system;

FIG. 4 is a top plan view, with ghost parts, of an embodiment of the present thermal-spraying device; and

FIG. 5 is a cross-section of a portion of the device of FIG. 4.

### DETAILED DESCRIPTION

FIG. 4 shows a thermal spraying device 50 comprising a plurality of chambers 51, a circulation channel 52, and liquid movement means 53. Moreover FIG. 4 shows (in ghost representation) an upper layer forming a nozzle plate 57 (FIG. 5), whereof only nozzles 58 are visible, as discussed in greater detail hereinafter, with reference to FIG. 5.

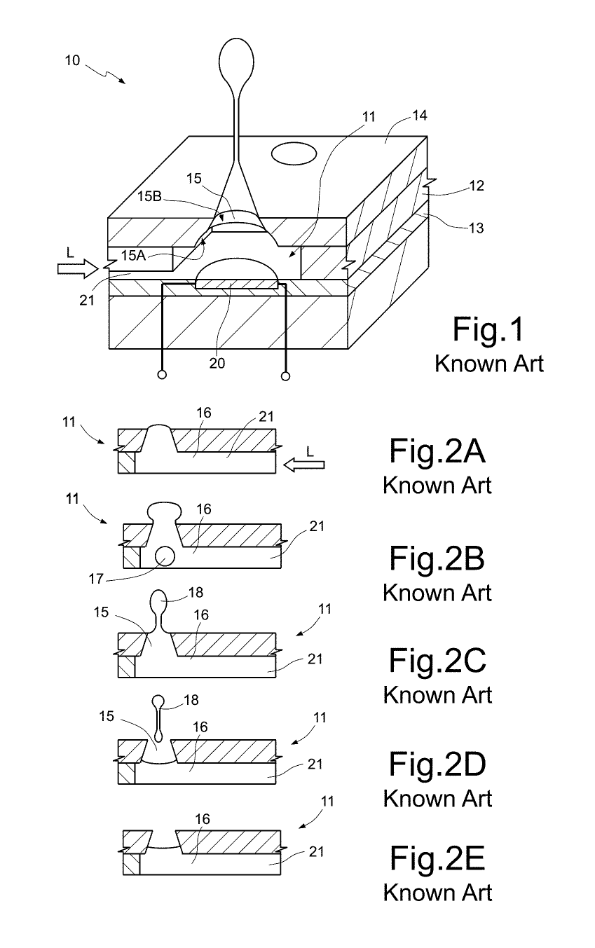

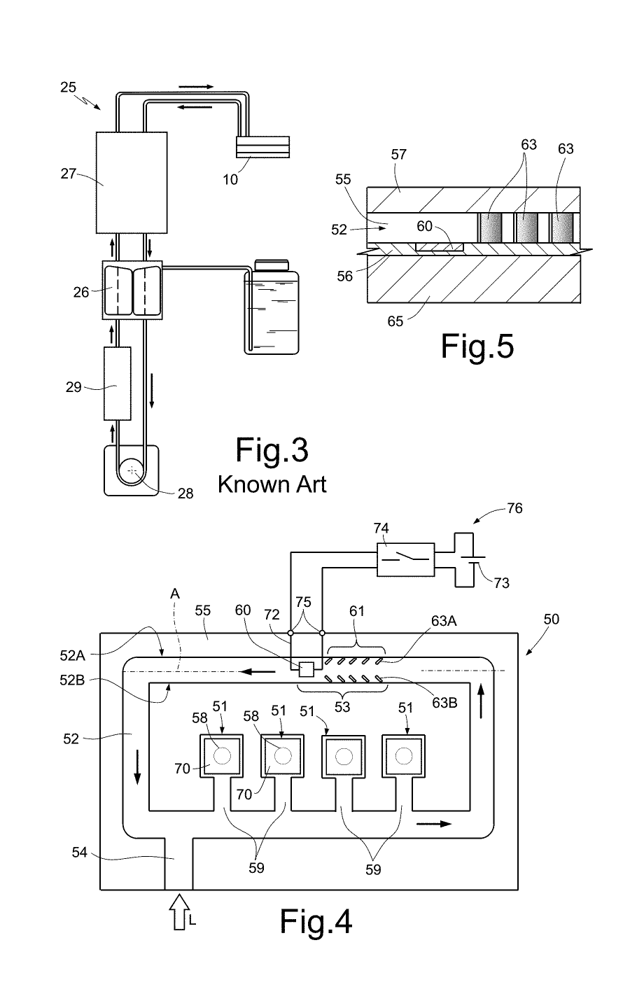

The chambers 51 may be formed as illustrated in FIG. 1, to which reference is made, and are each provided with a chamber heater 70.

In the illustrated embodiment, the circulation channel 52 extends along a closed line surrounding the plurality of chambers 51 and is fluidically connected to a supply channel 54, illustrated only schematically, supplied with a liquid L (of other fluid, such as a gas) in use. Each chamber 51 is connected to the circulation channel 52 by a respective liquid-access channel 59.

The liquid movement means 53 are here formed in the circulation channel 52.

As illustrated in detail in FIG. 5, the circulation channel 52 and the plurality of chambers 51 are formed inside a chamber layer 55 and are delimited at the bottom by a thin layer 56 and at the top by a nozzle plate 57, as may be seen in particular in FIG. 5. A substrate 65 is arranged under the thin layer 56 and is made, for example, of semiconductor material, such as monocrystalline silicon.

The chamber layer 56, similar to the chamber layer 12 of FIG. 1, is made, for example, of polymeric material, such as dry film, and can be obtained using lamination, reflow, lithographic and/or removal techniques, in a known known manner in the field of microinjectors. Alternatively, it can be molded and bonded onto the thin layer 56, or made by gluing structures of etched silicon.

The thin layer 56, similar to the thin layer 13 of FIG. 1, is made of insulating material, for example dielectric material, such as silicon oxide or/and silicon nitride.

The nozzle plate 57, similar to the nozzle plate 14 of FIG. 1, may be formed, for example, by a layer of polymeric material molded and bonded to the chamber layer 55.

As already mentioned and as shown in FIG. 1, the thermal spraying device 50 includes a plurality of nozzles 58 is arranged in the nozzle plate 57, each nozzle at a respective chamber 51.

The liquid movement means 53 are here formed by a channel heater 60 and a plurality of fluidic resistances 61.

The channel heater 60 is made like the chamber heaters 70. In particular, the channel heater 60 is formed by one or more strips of conductive material, formed in the thin layer 56 under the circulation channel 52. For instance, the channel heater 60 may be formed by layers of metal materials, such as tantalum, aluminum, tantalum silicon nitride, appropriately machined polymeric materials, and alloys of tantalum and aluminum, silicon chromium, tantalum silicon nitride or tungsten silicon nitride. The channel heater 60 is connected, via contacts 75 and electrical connection lines 72, to a control and supply unit 76, including a switching element, for example, a switch 74, and a power supply generator 73. The heater 60 and the electrical connection lines 72 may be formed according to the semiconductor technique, through deposition and/or sputtering, masking and etching.

The fluidic resistances 61 are here formed by walls 63 extending in the circulation channel 52 adjacent to the channel heater 60, in particular upstream of the channel heater 60, in a direction of movement of the liquid, indicated by arrows. The walls 63 may be of the same material as the chamber layer 55 and are defined in the same manufacturing step, via masking and etching, or molding of polymeric material.

In particular, the walls 63 extend on two mutually opposite sides 52A, 52B of the circulation channel 52 in a direction slanted with respect to a median vertical plane A, longitudinal to the circulation channel 52 in the considered area. The walls 63 here extend throughout the height of the circulation channel 52. In the embodiment illustrated, the walls 63 face each other two by two, forming pairs of walls 63, wherein each pair of walls comprises a first wall 63A and a second wall 63B, arranged specularly with respect to the median vertical plane A of the circulation channel 52. In this way, each pair of walls 63A, 63B creates a reduction of the liquid passage section so as to block the bubbles forming on the channel heater 60, as explained in detail hereinafter.

In use, the channel heater 60 is activated through the switch 74 during inactivity of the thermal spraying device 50 (and thus of the chamber heaters 70) and functions like the heater 20 of the prior art as regards formation of bubbles. In particular, the channel heater 60 heats the liquid layer present in the circulation channel 52 around the channel heater 60 up to a temperature at which a vapor bubble is formed, which subsequently bursts. Bursting of the bubble generates a thrust in the liquid that causes movement thereof into and along the circulation channel 52. The presence of the fluidic resistances 61 adjacent to the channel heater 60 ensures that the thrust impressed by the bubble on the liquid is exclusively in a direction opposite to fluidic resistances 61, thus ensuring a stable and continuous circulation.

As mentioned, the channel heater 60 is activated by the switch 74 when the process of thermal spraying is inactive, thus maintaining a continuous flow of liquid within the circulation channel 52 and thus preventing stagnation and aggregation of pigments in the liquid when it is not conveyed towards the chambers 51.

The thermal spraying device 50 described herein is advantageous as compared to the known solutions since it enables overcoming the problem of aggregation of the pigments in the liquid without having to resort to a complex and cumbersome system for recirculating the liquid outside the device, but just by adding liquid movement means 53 integrated in the thermal spraying device 50.

Finally, it is clear that modifications and variations may be made to the device and method described and illustrated herein, without thereby departing from the scope of the present disclosure.

For instance, the shape and arrangement of the circulation channel 52 may vary with respect to what illustrated. In particular, the circulation channel 52 might not surround the chambers 51 and/or may develop according to more complex lines, for example a labyrinth. The fluidic resistances could be obtained with different solutions, for example via restrictions in the circulation channel 52, or by appropriately sizing Tesla valves, for example manufactures as taught in U.S. Pat. No. 1,329,559 (see also http://www.epicphysics.com/model-engine-kits/tesla-turbine-kit/the-tesla-valve/).

The arrangement of the chambers 51 may differ from the illustrated one. For instance, the chambers 51 may be arranged so as to form an annulus or an S shape, or have some other nonlinear configuration.

The circulation channel 52 may be connected just to some of the chambers 51. For instance, the chambers 51 may be divided into different sectors, and the chambers of different sectors may be connected to different supply channels; for example, they may contain different liquids. In this case, the circulation channel may be connected only to the chambers 51 of one of the sectors. In this case, there is the advantage that recirculation can be dedicated and adapted to some of the chambers 51 instead of to all of them. This makes it possible to have chambers 51 dedicated to fluids with a tendency to aggregation, whereas other chambers 51 may be dedicated to fluids that can be controlled less problematically. For instance, some chambers 51 may be dedicated to perfumes with a tendency to aggregation and thus connected to a dedicated circulation channel 52, whereas other chambers 51, dedicated to humidification with water, have no recirculation.

The control and supply unit 76 may be integrated in the device 50 or arranged on a separate device.

Although the microfluidic devices shown in the Figures are heater actuated, the circulation channel, as well as the channel heater and fluidic resistances, also apply to piezoelectric actuated microfluidic devices.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A microfluidic device comprising:
a body including a plurality of chambers;
a plurality of nozzles covering the plurality of chambers, respectively;
a plurality of channel heaters associated with the plurality of chambers, respectively;
an access in fluid communication with the plurality of chambers; and
a circulation channel integrated in the body and in fluid communication with the access.

2. The device according to claim 1, further comprising liquid movement means in the circulation channel.

3. The device according to claim 2, wherein the liquid movement means comprises a channel heater arranged at the circulation channel.

4. The device according to claim 3, wherein the channel heater is located in an electrically insulating layer adjacent to the circulation channel.

5. The device according to claim 4, further comprising selective electrical connection means configured to couple the channel heater to a supply generator and decouple the channel heater from the supply generator.

6. The device according to claim 1, wherein the circulation channel is a closed-shaped channel.

7. The device according to claim 1, wherein the circulation channel extends around the plurality of chambers.

8. The device according to claim 1, comprising a fluidic path between the access and the plurality of chambers and forming part of the circulation channel.

9. The device according to claim 1, further comprising a fluidic resistance arranged in the circulation channel.

10. The device according to claim 9, further comprising liquid movement means in the circulation channel, wherein the fluidic resistance is adjacent to the liquid movement means.

11. The device according to claim 9, wherein the fluidic resistance comprises a plurality of walls extending through the circulation channel.

12. The device according to claim 11, wherein the walls comprise pairs of walls extending from opposite sides of the circulation channel and forming passage areas with reduced cross-section.

13. A method comprising:
operating a microfluidic device, wherein operating the microfluidic device includes:
circulating a liquid in a circulation channel;
providing the liquid in the circulation channel to the plurality of chambers; and
causing the liquid provided to the plurality of chambers to exit the microfluidic device through a plurality of nozzles associated with the plurality of chambers.

14. The method according to claim 13, wherein circulating the liquid comprises:
heating the liquid in the circulation channel; and
generating bubbles in the liquid.

15. The method according to claim 13, comprising generating a flow circulation direction of the liquid in the circulation channel by providing fluidic resistances in proximity of a channel heater that heats the liquid in the circulation channel.

16. The method according to claim 13, comprising interrupting circulation of the liquid in the channel during operation of the microfluidic device.

17. The method according to claim 13 wherein the circulation channel surrounds the plurality of chambers.

18. A microfluidic device comprising:
a body including a plurality of chambers and a circulation channel, the circulation channel being configured to provide a liquid to the plurality of chambers, the body including a heater proximate the circulation channel configured to heat the liquid and cause the liquid to flow in the circulation channel; and
a plurality of nozzles associated with the plurality of chambers, respectively, the plurality of nozzles being configured to eject the liquid in the plurality of chambers.

19. The microfluidic device according to claim 18, wherein the circulation channel includes fluidic obstacles proximate the heater, the fluidic obstacles being configured to resist thrust in one direction in the circulation channel, wherein the thrust is caused by bubbles in the liquid bursting.

20. The microfluidic device according to claim 19, wherein the fluidic obstacles are located upstream from the heater and are walls that extend into the circulation channel.

21. The microfluidic device according to claim 20, wherein the circulation channel is a closed channel that extends around the plurality of chambers.
